(19) United States
(12) Patent Application Publication
(10) Pub. No.: US 2019/0325035 A1
(43) Pub. Date: Oct. 24, 2019

(54) MULTI-USER PLAYLIST GENERATION FOR PLAYBACK OF MEDIA CONTENT

(71) Applicant: Microsoft Technology Licensing, LLC, Redmond, WA (US)

(72) Inventors: Itay Moshe Sagui, Kfar Saba (IL); Maayan Kislev, Tel Aviv (IL); Yuval Borsutsky, Rishon LeZion (IL); Nitzan Parness, Tel Aviv (IL); Eliraz Cohen, Ramat Gan (IL); Bassel Saba, Tel Aviv (IL); Ravit Dennis, Hertzeliya (IL); Michael Sachter, Raanana (IL)

(21) Appl. No.: 15/959,779

(22) Filed: Apr. 23, 2018

(51) Int. Cl. G06F 17/30; H04L 29/06

(52) U.S. Cl. CPC G06F 17/30053; H04L 65/60; G06F 17/3053; G06F 17/30038; G06F 17/30026

(57) ABSTRACT

Systems, methods, and apparatuses are provided for generating a merged media playlist. A plurality of playlists is obtained, each playlist including a plurality of identifiers that identify an item of media content, such as a song. For each item of media content identified in each of the playlists, a feature value is obtained. The feature value may be, for instance, a value representing a characteristic associated with the item of media content. A feature score may be generated for each of the one or more features that is based on the number of occurrences of the feature value associated with the particular feature in a given playlist. The feature scores may then be used to generate a media content item score for each item of media content in each playlist. Based, at least on the media content item scores, a merged media playlist may be generated and ordered.

### BACKGROUND

Music files may be arranged in playlists that enable a user to listen to numerous songs in a successive manner. To create an individual playlist, a user typically selects which songs to add and sorts the songs in a desired order. In some other instances, users may utilize an online service to play back a list of songs based on their music preferences. Often times, it is desirable to play back music for number of listeners. However, creating a single playlist that combines playlists of multiple users becomes problematic where those have different tastes in their selection of music. In such scenarios, merging various playlists into a single playlist that takes into account each of the user's preferences is both difficult and time consuming. For instance, an individual seeking to create a single combined playlist may manually need to select songs from each user's separate playlist based on the individual's own perception regarding each user's music tastes. However, even with such manual methods of combining various playlists, a user's ability to combine playlists is limited by the user's knowledge of each song. For example, if the user responsible for generating a combined playlist is not familiar with a particular song in another user's playlist, the song may be left out of a combined playlist. As the number of users increases, the difficulty in creating a combined playlist that takes into account the preferences of various users also increases.

In other methods, a user may alternatively play each playlist separately or create a single combined playlist by adding every song in the various playlists to a single playlist. In these methods, however, playback of songs is merely based on identifying songs present in individual playlists, but fails to take into account individual preferences or attributes associated with each song. Furthermore, not only would such methods would require a user to expend time in separately playing back or adding songs from every playlist into a single list, the user would also unnecessarily consume additional resources by downloading each playlist and songs identified in each playlist and storing such playlists and songs on the user's device for playback. With a larger number of playlists, the inefficiencies of such methods grow further.

In addition, the individual has no easy way to determine how to sort the songs in a combined playlist other than manually sorting the list based on the individual's own preferences or randomly sorting the list. However, neither manner takes into account each user's music preferences on a song-by-song basis. Rather, the composition and arrangement of the combined playlist is generally left up to the discretion of the individual responsible for the manual combining task.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are provided for generating a merged media playlist. A plurality of playlists is obtained, each playlist including a plurality of identifiers that identify an item of media content, such as a song. For each item of media content identified in each of the playlists, a feature value is obtained. The feature value may be, for instance, a value representing a feature or a media characteristic associated with the item of media content. A feature score may be generated for each of the one or more features that is based on the number of occurrences of the feature value associated with the particular feature in a given playlist. The feature scores may then be used to generate a media content item score for each item of media content in each playlist. Based, at least on the media content item scores, a merged media playlist may be generated and ordered.

In this manner, a playlist may be automatically generated that takes into account the interests of individual users on an item-by-item basis. For instance, by analyzing and scoring features for each song in each playlist, preferences of users may thereby be determined based on actual characteristics associated with each item. In an example, if the majority of a user's playlist items comprise music belonging to a particular genre or artist, it can automatically be determined that the particular genre or artist is important to the user. By analyzing and scoring features for items across multiple playlists of multiple users and combining those scores, a merged list may be generated that takes into account the collective interests of all the users.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the embodiments and to enable a person skilled in the pertinent art to make and use the example embodiments.

FIG. 1 shows a block diagram of a system for merging a media playlist, according to an example embodiment.

FIG. 2 shows a flowchart of a method for generating a merged media playlist, according to an example embodiment.

FIG. 3 shows a block diagram of a media content playlist merger, according to an example embodiment.

FIG. 4 shows a flowchart of a method for obtaining a feature value associated with a media content item, according to an example embodiment.

FIG. 5 shows a flowchart of a method for generating a media content item score for an item of media content, according to an example embodiment.

FIG. 6 shows a flowchart of a method for increasing a media content item score associated with an item of media content, according to an example embodiment.

FIG. 7 shows a block diagram of a system for merging a media playlist, according to another example embodiment.

FIG. 8 shows a block diagram of a system for merging a media playlist, according to yet another example embodiment.

FIG. 9 shows a flowchart of a method for obtaining a media playlist of a user, according to an example embodiment.

FIG. 10 is a block diagram of an example mobile device that may be used to implement various example embodiments.

FIG. 11 is a block diagram of an example processor-based computer system that may be used to implement various example embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, are understood to mean that the condition or characteristic is defined to within tolerances that are acceptable for operation of the implementation for an application for which it is intended.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

As noted in the Background section above, music files may be arranged in playlists that enable a user to listen to numerous songs in a successive manner. To create an individual playlist, a user typically selects which songs to add and sorts the songs in a desired order. In some other instances, users may utilize an online service to play back a list of songs based on their music preferences. Often, it is desirable to play back music for number of listeners. However, creating a single playlist that combines playlists of multiple users becomes problematic where those users have different tastes in their selection of music. In such scenarios, merging various playlists into a single playlist that takes into account each of the user's preferences is both difficult and time consuming. For instance, an individual seeking to create a single combined playlist may manually need to select songs from each user's separate playlist based on the individual's own perception regarding each user's music tastes. However, even with such manual methods of combining various playlists, a user's ability to combine playlists is limited by the user's knowledge of each song. For example, if the user responsible for generating a combined playlist is not familiar with a particular song in another user's playlist, the song may be left out of a combined playlist. As the number of users increases, the difficulty in creating a combined playlist that takes into account the preferences of various users also increases.

In other methods, a user may alternatively play each playlist separately or create a single combined playlist by adding every song in the various playlists to a single playlist. In these methods, however, playback of songs is merely based on identifying songs present in individual playlists, but fails to take into account individual preferences or attributes associated with each song. Furthermore, not only would such methods would require a user to expend time in separately playing back or adding songs from every playlist into a single list, the user would also unnecessarily consume additional resources by downloading each playlist and songs identified in each playlist and storing such playlists and songs on the user's device for playback. With a larger number of playlists, the inefficiencies of such methods grow further.

In addition, the individual has no easy way to determine how to sort the songs in a combined playlist other than manually sorting the list based on the individual's own preferences or randomly sorting the list. However, neither approach takes into account each user's music preferences on a song-by-song basis. Rather, the composition and arrangement of the combined playlist is generally left up to the discretion of the individual responsible for the manual combining task.

Implementations described herein address these and other issues through a media content playlist merger that includes a media playlist obtainer, a feature extractor, a score generator, and a media playlist merger. The media playlist obtainer may obtain a plurality of media playlists, e.g., playlists corresponding to various different users or listeners. Each playlist may include an identifier for each item of media content, such as a song. For each item of media content, the feature extractor may obtain a feature value for any number of features. A feature may include any characteristic associated with an item of media content. Where the media content item is a song, for instance, features may include a song name, an artist name, a beat, a genre, among many others. The score generator may generate a feature score based on the obtained feature value for each feature. For example, the feature score for a given feature may be generated based on a number of times the feature value for a particular feature appears in the media playlist. In other words, the feature score for a given feature may be relatively high where a relatively large number of other media content items in the same playlist share the same feature value for the same feature. As an example, if the majority of songs in a particular playlist belong to a particular genre (e.g., the “genre” feature for the majority of songs have a feature value of “jazz”), it can be deduced that the user prefers that particular genre, and therefore the feature score assigned to the “genre” feature may be relatively high compared to other feature scores.

Based on the feature scores, the score generator may generate a single media content item score for each media content item. This scoring process may be performed for each media item in each playlist. In this manner, each media content item may be associated with a score corresponding to the preferences (e.g., music preferences) of a particular user. The score associated with a given media content item may be increased if the media content item appears in multiple ones of the playlists to be merged, thereby elevating the scores of media content items liked by multiple users. Upon scoring each media content item for each playlist, the media playlist merger may combine the identifiers of the media content items from the various playlists and order the combined identifiers using the media content item scores. In this way, the merged playlist comprises a merged playlist that takes into account the determined preferences across multiple users.

This approach has numerous advantages, including but not limited to generating and ordering a merged media playlist based on a plurality of users' unique tastes, such that items of media content matching the preferences of users may be arranged near the top of the merged playlist. Furthermore, the merging of the playlists may be carried out automatically, thereby enabling the generation of a merged playlist with reduced user involvement. In addition, because the scoring may be tuned based on a variety of factors, such as a customized list of features for which values are obtained and/or weighting factors that may be utilized to increase or decrease the value of certain features, the generation of the merged playlist may be carried out in a manner that also takes into account preferences of an operator (e.g., a media content delivery services operator, or an owner of an establishment such as a bar, restaurant or club, in which music is being played for customers).

Accordingly, implementations can provide at least the following capabilities pertaining to the generation of a merged media playlist: (1) a mechanism to generate and order a merged media playlist based on a plurality of users' unique tastes; (2) a mechanism for automatically generating a merged playlist based on scores generated for each item of media content in each media playlist; and (3) a mechanism for tailoring the generation of the merged playlist based on an operator's preferences in addition to the preferences of the various users.

Furthermore, implementations described herein may reduce the resources consumed by a computer system, thereby improving the performance and efficiency of the computer system. For instance, by generating a single merged playlist that takes into account the preferences of a plurality of users, a media content playback client need not receive each user's individual playlist (and media content items contained therein) therefore decreasing the bandwidth and memory required by the media content playback client. Moreover, by implementing a media content playlist merger on a media content delivery service (e.g., on a cloud) and ordering the items in the playlist based on user preferences, the media content playback client need not consume resources in analyzing items of media for each individual user. Furthermore, resources consumed by a media content delivery service may also be reduced since the delivery service may transmit a stream of media content items in the merged media playlist to fewer users (e.g., a user of the media content playback client), rather than transmit separate streams of media content to be played back by each individual user logged into a corresponding account on the media content delivery service. Furthermore, by generating and ordering playlists in response to playlist generation requests instead of pre-storing playlists, the system further improves the manner of data storage and retrieval in memory, allowing for more efficient use of storage space and system resources.

Such improvements further allow the system to support and provide services to playback client devices that may have limited resources or have access to limited bandwidth. For example, a media playback client need not utilize resources in downloading and storing each individual media playlist (and items contained therein), but rather may preserve bandwidth and memory since only a single merged media playlist is retrieved. Additionally, since the merged playlist may be generated and ordered in a manner consistent with the individual user preferences, the media content playback client may present (e.g., stream) the items of media content as they are received with relatively little processing. Where the media playback client is a portable device (e.g., a smartphone, a tablet, a wireless speaker, etc.), the reduction in bandwidth, memory, and processing resources may further preserve the device's battery, enabling the device to perform other tasks more efficiently and/or play back media content in the merged playlist for a longer period of time.

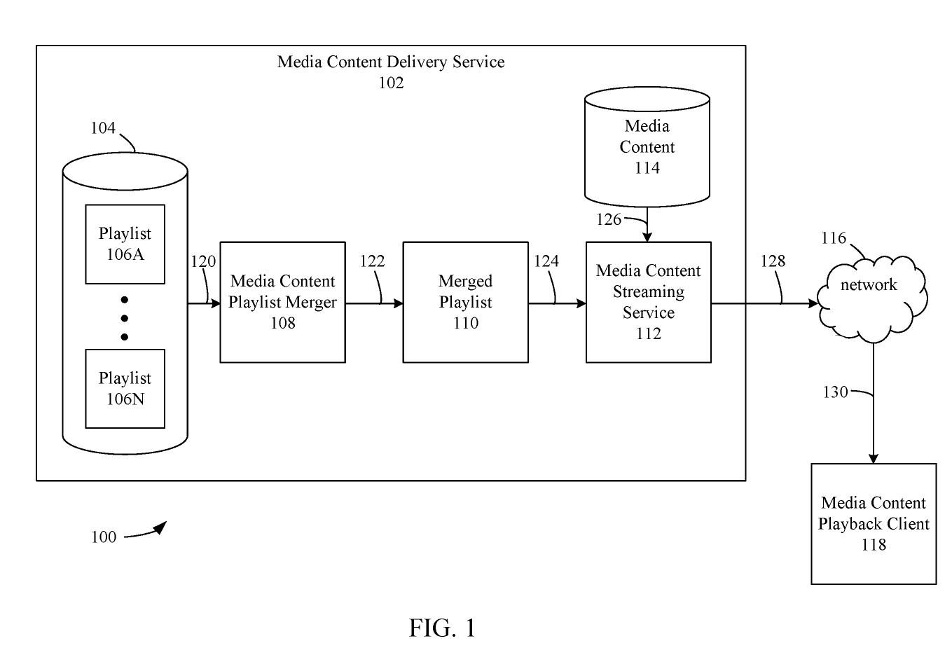

Example implementations will now be described that are directed to techniques for generating a merged media playlist. For instance, FIG. 1 shows a block diagram of an example system 100 for generating a merged media playlist, according to an example implementation. As shown in FIG. 1, system 100 includes a media content delivery service 102, a network 116, and a media content playback client 118. Media content delivery service 102 includes a playlist repository 104, a media content playlist merger 108, a merged playlist 110, a media content streaming service 112, and a media content repository 114. Network 110 may comprise one or more networks such as local area networks (LANs), wide area networks (WANs), enterprise networks, the Internet, etc., and may include one or more of wired and/or wireless portions. Media content delivery service 102 is communicatively connected to media content playback client 118 via network 116. In an implementation, media content delivery service 102 and media content playback client 118 may communicate via one or more application programming interfaces (API).

Media content delivery service 102 (and any of the components or subcomponents thereof) may be implemented in one or more physical machines (e.g., servers) or virtual machines. Where media content delivery service 102 is implemented by a plurality of servers, such servers may form a network-accessible server infrastructure, such as a cloud computing server network. For example, media content delivery service 102 may comprise a group or collection of servers (e.g., computing devices) that are each accessible by a network such as the Internet (e.g., in a “cloud-based” implementation) to store, manage, and process data. Media content delivery service 102 may comprise any number of computing devices, and may include any type and number of other resources, including resources that facilitate communications with and between the servers, storage by the servers, etc. (e.g., network switches, storage devices, networks, etc.). Each such server implementing media content delivery service 102 may be organized in any manner, including being grouped in server racks, server clusters, or datacenters. In an implementation, servers may be co-located (e.g., housed in one or more nearby buildings with associated components such as backup power supplies, redundant data communications, environmental controls, etc.) to form a datacenter, or may be arranged in other manners. Accordingly, in one implementation, servers implementing media content delivery service 102 may each be a datacenter in a distributed collection of datacenters.

Playlist repository 104 includes playlists 106A-106N. Playlists 106A-106N include playlists corresponding to one or more users or user devices. As shown in FIG. 1, playlist repository 104 may be included within media content delivery service 102. For instance, media content delivery service 102 may contain one or more storage devices suitable for storing playlist repository 104. In another example, playlist repository 104 may be distributed to or across one or more physical machines, virtual machines, nodes, or servers. It is noted that although playlist repository 104 is shown in FIG. 1 as included within media content delivery service 102, playlist repository 104 (or any of playlists 106A-106N) may also be externally located with respect to media content delivery service 102. For instance, any of playlists 106A-106N, or playlist repository 104, may be located on any suitable storage device, physical machine, virtual machine, node, or server accessible by media content delivery service 102 (e.g., via network 116).

In an implementation, playlists 106A-106N may comprise a plurality of media playlists. Each media playlist may also contain a plurality of identifiers, each identifier identifying an item of media content. For instance, a media playlist may include an audio or song playlist including a plurality of identifiers, each identifier identifying a particular audio item or song. Playlists may be generated by a user (e.g., through manual interaction with a computing device), by an online streaming service or subscription, or both. Media playlists may comprise any suitable content and/or format. In example embodiments, playlists 106A-106N may comprise files, databases, documents, tables, data structures, etc. In an example, an audio or music identifier in a playlist may include a title or song name, an artist, an album name, a genre, a release date, a track number, and/or any other information that may be used to identify or characterize a particular audio item or song. Identifiers may take any suitable form, such as a metadata container associated with each item of media content. In one implementation, an identifier may comprise an ID3 tag or the like. Identifiers may also comprise one or more fields that may be modified by a user and/or may be updated automatically.

Note that the variable “N” is appended to various reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

Media playlists described herein are not limited to playlists comprising identifiers identifying items of audio or music content. In other implementations, a media playlist may include a video playlist including a plurality of identifiers identifying a plurality of videos comprising audio/video content, or only video content for playback. For instance, the video playlist may comprise a list of television shows, movies, short films, etc. In one example embodiment, the video playlist may be stored on a media content delivery service, such as streaming services provided by NetFlix®, Hulu®, YouTube®, Apple® TV, or the like. In yet another implementation, a media playlist may include identifiers associated with a plurality of images (e.g., personal and/or family photos, vacation photos, etc.). In yet another example embodiment, a media playlist may comprise a plurality of identifiers associated with a video game. For instance, a video game playlist may comprise a plurality of video game maps representing a gameplay location. The implementations are not intended to be limiting, and may include any other type of media content that may be selected, saved, streamed, accessed, shared, viewed, played, etc.

Media content playlist merger 108 may be configured to obtain 120 playlists 106A-106N. Based on playlists 106A-106N, and media item identifiers included therein, media content playlist merger 108 may obtain a feature value for one or more features for each item of media content for each media playlist. Media content playlist merger 108 may further generate a feature score for each feature. For instance, the feature score may be based on a number of times the feature value associated with a particular feature appears in the media playlist in which the item of media content is identified. Based on the feature scores, media content playlist merger 108 may generate a media content item score for each item of media content in each media playlist.

Using the media content item scores, media content playlist merger 108 may generate 122 merged playlist 110. In an implementation, merged playlist 110 may include a combination of identifiers associated with the items of media content in one or more of playlists 106A-106N. For instance, merged playlist 110 may include identifiers corresponding to each item of media content in playlists 106A-106N. In another implementation, merged playlist 110 may include a subset of identifiers across playlists 106A-106N, based for instance, on the generated media content item scores. For example, merged playlist 110 may include identifiers of items of media content above a threshold media content item score. In yet another implementation, merged playlist 110 may include a predetermined or user-configurable number of identifiers, such as the identifiers associated with the top 25, 50, 100, etc. media content item scores.

Merged playlist 110 may also comprise an ordered or sorted playlist. For instance, merged playlist 110 may be ordered based on the media content item scores. As one example, the media content identifiers in merged playlist 110 may be arranged in descending order by media content item score, such that the item of media content with the highest media content item score is identified first in merged playlist 110 and the item of media content with the lowest media content item score is identified last in merged playlist 110. In some other implementations, merged playlist 110 may include multiple instances of the same identifier. For example, if a particular item of media content had a high media content item score (e.g., above a threshold value), the identifier associated with the particular item of media content may appear multiple times in merged playlist 110.

Media content streaming service 112 may be a service configured to obtain 124 merged playlist 110 and transmit or stream 128 items of media content identified in merged playlist 110 from media content repository 114 to one or more playback devices over network 116. For instance, media content streaming service 112 may identify a plurality of identifiers of items of media content in merged playlist 110 and stream each identified item of media content over network 116. In one example embodiment, media content streaming service may obtain 126 items of media content from media content repository 114 in an order specified by merged playlist 110 and stream 128 such items to media content playback client 118 in the specified order. In another example, media content streaming service 112 may modify an order in which items of media content identified in merged playlist 110 are streamed to media content playback client 118 in a random manner. In another implementation, media content streaming service 112 may also obtain feature values, feature scores, and/or media content item scores for each item of media content identified in merged playlist 110. Using the feature values, feature scores, and/or media content item scores, media content streaming service 112 may identify and stream one or more additional items of media content that are deemed similar to items of media content identified in merged playlist 110.

Media content repository 114 may store items of media content, and may comprise any suitable storage device or system for performing this task. Media content repository 114 may be located locally with respect to media content streaming service 102 or located remotely with respect to media content streaming service 102 such that media content repository 114 is accessed thereby via network 116. For instance, media content repository 114 may comprise a storage medium that is distributed across one or more physical machines, virtual machines, nodes, or servers which may be part of or external to media content delivery service 102. Although shown in FIG. 1 as a single repository, media content repository 114 may comprise a plurality of media content repositories.

Media content playback client 118 may comprise any device configured to present (e.g., display and/or play back) the items of media content of merged playlist 110 for consumption by a user. For instance, media content playback client 118 may include any device capable of receiving 130 items of media content in merged playlist 110 that are streamed from media content delivery service 112.

In one example, media content playback client 118 may comprise a computing device. For instance, media content playback client 118 may include the computing devices of users that access media content streaming service 112 to stream items of media content through network 116. Such users may include individual users, establishments (e.g., restaurants, bars, clubs, etc.), disc jockeys (e.g., event disc jockeys, radio station disc jockeys, etc.), or any other entity desiring to playback items of media content.

Although FIG. 1 shows only a single media content playback client, it is to be understood that system 100 may comprise any number of media content playback clients 118 and that such media content playback clients 118 may be located in any remote location. Media content playback client 118 may be a mobile device, including but not limited to a mobile computing device (e.g., a Microsoft® Surface® device, a personal digital assistant (PDA), a laptop computer, a notebook computer, a tablet computer such as an Apple iPad™, a netbook, etc.), a mobile phone, a handheld video game device, or a wearable computing device. Media content playback client 118 may also be a stationary device such as but not limited to a desktop computer or PC (personal computer), a video game console, a set-top box, a television, or a smart device, such as a voice-activated home assistant device. Media content playback client 118 may also be devices that are integrated into appliances, vehicles or other systems. Media content playback client 118 may interface with media content streaming service 112 through APIs and/or by other mechanisms, such as a web browser (e.g., Microsoft® Internet Explorer, Google® Chrome, Apple® Safari, etc.). Note that any number of program interfaces or web browsers may be present. Although it is shown herein that media content delivery service 102 is coupled to media content playback client via network 116, other implementations are also contemplated. For instance, media content playback client 118 may be local with respect to media content delivery service 102.

In another example, media content playback client 118 may comprise a standalone output device capable of playing back media content. For instance, media content playback client 118 may be a device comprising at least a processor, a memory, a speaker, and an audio and/or video interface (e.g., a device such as Google® Home, Amazon® Alexa, etc.). Such a device may be configured to access and/or execute one or more services, including a media playback service for playing back items of media content in merged playlist 110 streamed from media content streaming service 102 via one or more local networks and/or network 116.

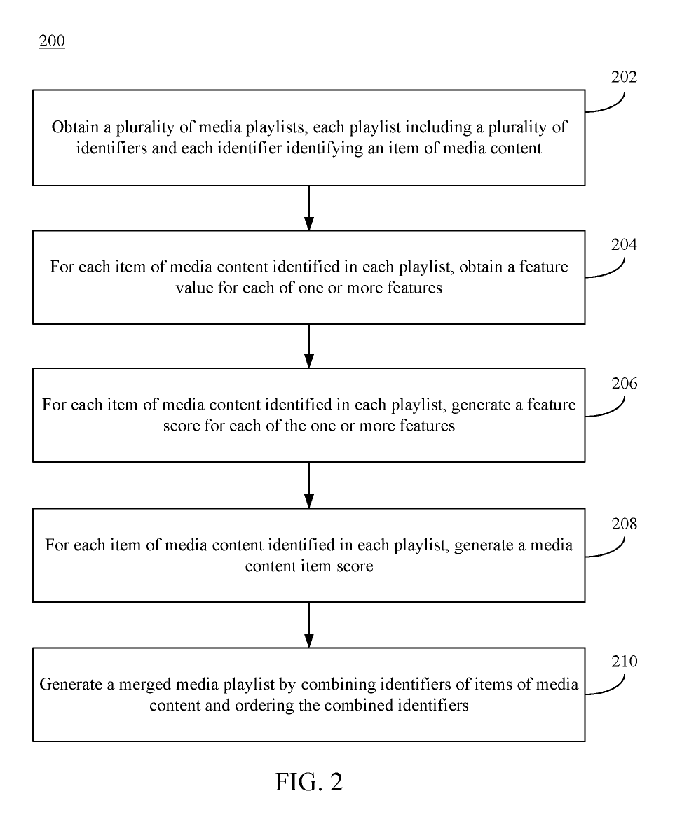

Accordingly, in implementations, merging of a plurality of playlists 106A-106N may be achieved. Media content playlist merger 108 may generate a merged playlist 110 in various ways. For example, FIG. 2 shows a flowchart 200 of a method for generating a merged media playlist, according to an example embodiment. In an implementation, the method of flowchart 200 may be implemented by media content playlist merger 108. FIG. 2 is described with continued reference to FIG. 1. Other structural and operational implementations will be apparent to persons skilled in the relevant art(s) based on the following discussion regarding flowchart 200 and system 100 of FIG. 1.

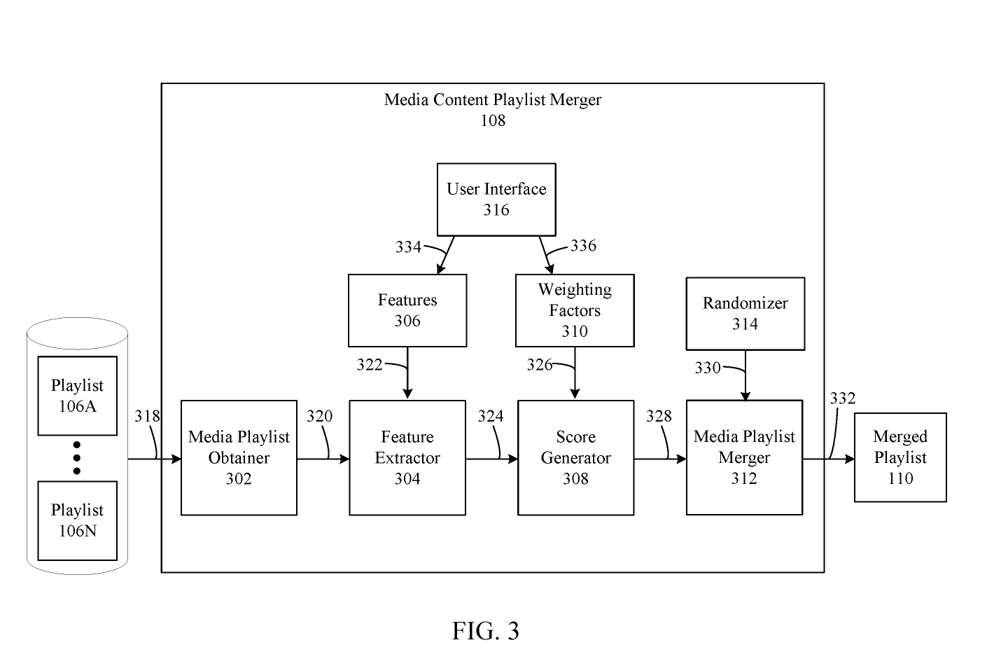

Flowchart 200 begins with step 202. In step 202, a plurality of media playlists is obtained. Each playlist of the plurality of playlists may include a plurality of identifiers, each of which identifies an item of media content. For instance, with reference to FIG. 1, media content playlist merger 108 may obtain playlists 106A-106N corresponding to one or more users or user devices (e.g., user accounts). Each of playlists 106A-106N may include identifiers identifying each item of media content contained therein. Step 202 may also be performed in accordance with other implementations. For instance, FIG. 3 shows a block diagram of media content playlist merger 108, according to an example embodiment. As shown in FIG. 3, media content playlist merger 108 includes a media playlist obtainer 302, a feature extractor 304, features 306, a score generator 308, weighting factors 310, a media playlist merger 312, a randomizer 314, and a user interface 316.

In accordance with step 202, media playlist obtainer 302 may be configured to obtain 318 playlists 106A-106N. For example, media playlist obtainer 302 may obtain playlists 106A-106N automatically or upon an event occurrence. In one implementation, a user or administrator of media content playlist merger 108 may trigger media playlist obtainer 302 to obtain playlists 106A-106N. In another implementation, a user corresponding to one of playlists 106A-106N may provide an indication to transmit the playlist corresponding to the user to media playlist obtainer 302 or authorize a service (e.g., a media content streaming service) to provide the user's playlist to media playlist obtainer 302. It is understood and appreciated that the examples of providing playlists 106A-106N are not limiting and may include any other suitable manner of providing a playlist corresponding to a user or a user device to media playlist obtainer 302.

As noted earlier, each playlist 106A-106N may comprise a plurality of identifiers. An identifier may identify a particular item of media content located in a given playlist. For example, if playlists 106A-106N comprise music playlists, the identifier may comprise a song name, an artist, an album, etc., or any other information that may identify a particular song. As playlists 106A-106N comprise playlists of a plurality of users or user devices, media playlist obtainer 302 may thereby obtain identifiers for each item of media content in each of the obtained playlists. As will be discussed below in greater detail, the obtained playlists may be combined into a merged playlist in accordance with implementations described herein.

In step 204, for each item of media content identified in each playlist, a feature value for each of one or more features is obtained. For instance, with continued reference to FIG. 3, feature extractor 304 obtains 320 each playlist obtained by media playlist obtainer 302 and obtains 322 a list of features 306. For each of the features for which feature values are to be obtained, feature extractor 304 obtains a feature value for each item of media content in each playlist. As an example, if one of features 306 corresponds to a music genre, feature extractor 304 would obtain, for each item of media content in each of playlists 106A-106N, a feature value (e.g., jazz, classical, rock, etc.) is obtained corresponding to the music genre. As will be described in more detail below, feature extractor 304 may obtain a feature value in a variety of ways, including by analyzing metadata associated with an item of media content and/or analyzing the item of media content itself. Feature extractor 304 may also obtain or import feature values for one or more features 306 from another service, remote repository, or a centralized or cloud-based storage in some other implementations.

Features 306 may comprise any type and number of features. For instance, features 306 may correspond to any type of media characteristic associated with an item of media content and/or used to categorize an item of media content. As non-limiting examples, where features 306 characterize features of songs, features 306 may include a song artist or composer, an album name, a song name, a genre, an identification of instruments used in a song, a tempo, a beat, a pitch, a dynamic range value, a loudness value, a bass and/or treble amount, a country of origin, a song language, an intended audience, a creation date or release date, an indication of whether a song was live or prerecorded, an indication whether a song is an original recording and/or a cover version, an indication of whether a song is part of a movie soundtrack, a size of an artist or band associated with the song, a gender of the artist or members of a band associated with the song, a length of the song, and/or an amount of plays or a popularity rating or ranking. Where features 306 characterize features of other types of media, as described as examples herein, features 306 may include similar types of characteristics for that type of media.

A feature value obtained by feature extractor 304 may comprise any suitable format, including text, numbers, ratings, etc. For instance, for a feature corresponding to a music genre, the feature value may be a text string of “jazz” or “classical,” or the like. If the feature corresponds to a release date, the feature value may be “2015” or “Jan. 1, 2015” or any other suitable format. It is noted that the feature value may also comprise a flag, such as a “yes” or “no” value or a binary value, for one or more features 306. For instance, if features 306 include an identification of instruments used in a song, feature extractor 304 may obtain a separate feature value of “yes” or “no” corresponding to a plurality of instruments (e.g., guitar, piano, drums, etc.).

Features 306 are not limited to the examples identified herein but may include any other feature that may be used to characterize or otherwise categorize or cluster items of media content. For instance, where playlists 106A-106N comprise image, audio/video, and/or video playlists, features 306 may include features relating to color levels, brightness levels, contrast levels, clarity (e.g., high-definition or standard definition, resolution, etc.), a negativity, an identification of objects, scenes, or settings present in one or more frames (e.g., animals, humans, particular scenes or settings, etc.), or any other information that may be derived or extracted from an image, audio/video file, or video file. In an implementation where playlists 106A-106N comprise video game map playlists, features 306 may comprise an identification of objects or settings present in the video game map (e.g., trees, desert, oceans, mountains, types of buildings, etc.), a size of a video game map, an altitude level corresponding to the video game map, a number of video game players supported by the map, or any other features relating to video game maps or gameplay associated with such maps.

In one implementation, features 306 for which feature extractor 304 obtains feature values may be configured 334 through user interface 316. For instance, a user or administrator can log in to an account (e.g., via media content playback client 118 or any other suitable device) associated with the media content playlist merger 108 to access features 306. A user or administrator can view, add, and/or remove features 306 for which feature extractor 304 obtains values. As an example, one user may wish to obtain feature values for only three features (e.g., song name, genre, and artist) across a plurality of items of media content in playlists 106A-106N. Another user may instead desire to configure feature extractor 304 to obtain feature values for dozens of features across a plurality of items of media content in playlists 106A-106N. In this manner, media content playlist merger 108 can generate a merged playlist in accordance with the user or administrator's preferences.

In step 206, for each item of media content identified in each playlist, a feature score for each of the one or more features is generated. For example, with reference to FIG. 3, score generator 308 may obtain 324 feature values obtained by feature extractor 304 and generate a feature score for each corresponding feature. In an example embodiment, the feature score for a particular feature may comprise a numerical value that is based on at least the feature value for the feature. In one implementation, score generator 308 may generate a feature score based also on feature values for the same feature for other items of media content in the same playlist. For instance, score generator 308 may generate a feature score for a particular feature based on a number of occurrences of the feature value associated with the particular feature in playlist from which the item of media content is identified.

In this manner, score generator 308 may generate a feature score for a particular feature that is based on a relative frequency of the same feature value in the same playlist. By generating such a feature score, score generator 308 may assign a higher feature score for feature values that are common in the playlist for that feature. As an illustrative example, a given media playlist may comprise 100 identifiers identifying 100 items of media content (e.g., 100 songs). If one of features 306 comprised a song genre and 85 of the 100 songs are categorized as jazz (i.e., the feature value for the song genre feature is “jazz”), score generator 308 may generate a feature score of 0.85 for the song genre feature for each jazz song identified in the playlist. If the remaining 15 songs were categorized as classical, score generator 308 may generate a feature score of 0.15 for the song genre feature for each classical song. This process may be repeated until score generator 308 generates a feature score for each feature for each item of media content in each playlist. Although score generator 308 generates decimal values for feature scores in this illustrative example (e.g., 85/100, or 0.85 for jazz songs), score generator 308 is not limited to generating decimal values, but rather may generate feature scores in other manners and based on any scale. For instance, score generator 308 may generate feature scores in the tens or hundreds.

Score generator 308 is also not limited to generating feature scores based on a number of occurrences of a particular feature value for a feature in a playlist. Score generator 308 may also generate a feature score for a particular feature in other manner, including based on any other measure related to or mathematically derived from a number of occurrences of the same feature value in the playlist in which the item of media content is identified. For instance, score generator 308 may generate a feature score based on a linear, logarithmic, exponential, etc. function based on a number of occurrences of the same feature value for the feature in the playlist. In another non-limiting example score generator 308 may generate feature scores that utilize a raw value corresponding to a number of occurrences of the same feature value in the playlist, or another value generated from the raw value, or any suitable statistical or mathematical analysis.

In another implementation, score generator 308 may generate feature scores based on data regarding user preferences from other sources of information, such as user specified preferences or public and/or private webpages (e.g., social media pages or platforms) of the user or user's friends to determine the importance of one or more features for a given user. Score generator 308 may also generate feature scores based on demographics associated with a user (e.g., age, location, etc.). In yet another example, score generator 308 may generate feature scores based on media content of in another media playlist (e.g., one or more playlists of family members, friends, colleagues, social media connections, etc.) or on based on preferences of one or more other users. Still other methods may be used to generate a feature score for each of the one or more features.

In step 208, for each item of media content identified in each media playlist, a media content item score is generated. For instance, with reference to FIG. 3, score generator 308 may generate a media content item score for each item of media content. In an example embodiment, the media content item score for an item of media content may be based on one or more of the feature scores for the item of media content. For example, if score generator 308 is configured to generate three separate feature scores corresponding to three features (e.g., song name, genre, and artist), score generator 308 may generate a single media content item score based on the three feature scores for that item of media content.

In one implementation, the media content item score may be an aggregation or summation of all the feature scores associated with a particular item of media content. In another example, the media content score may be based on a subset of the feature scores associated with a particular item of media content. For instance, the media content item score may be based one or more of the highest and/or lowest feature scores for the item of media content (e.g., the top and/or bottom 3, 5, 10, etc. feature scores for a particular item of media content). Score generator 308 may also generate media content item scores based on any other mathematical or statistical analysis of the feature scores for a particular item of media content (e.g., an average of the feature scores, one or more feature scores exceeding or falling below a threshold value, etc., or any combination thereof). In one example implementation, score generator 308 may remove one or more of the highest or lowest feature scores or remove feature scores exceeding or falling below a threshold value (e.g., removing outliers). In another example, score generator 308 may normalize media content item scores for all the items of media content in a particular playlist. In another implementation, score generator 308 may generate a media content item score that is a raw aggregation of the feature scores for an item of media content (e.g., the media content item score can be any value on any scale).

In other implementations, the media content item score may be increased or decreased based on a variety of other factors. For instance, the media content item score may be increased if a song is played relatively often by a user or is liked by a user, or if the playlist from which the song originates is played relatively often by a user or is liked by a user. The media content item score may also be modified based on an origination source of the media content identifier in a given playlist. As an example, if a user manually added a particular song to a playlist or manually generated an entire playlist, media content scores for such songs may be increased. Conversely, if identifiers of media content in a given playlist were automatically generated (e.g., by a media content streaming service), or generated by another user (e.g., a friend, family member, colleague, etc.), the media content scores for such songs may be decreased.

By generating feature scores based on a relative frequency of feature values in a given playlist and combining the feature scores to generate a single media content item score for each item of media content, each item of media content may be associated with a value indicative of its relative importance to a user. For instance, items of media content with a high media content item score may represent items that a user enjoys listening to. In this manner, a user's preferences regarding each item of media content, based on a frequency associated with feature values associated with the item of media content, may be represented by single score.

In step 210, a merged media playlist may be generated by combining identifiers of items of media content and ordering the combined identifiers based on the media content item scores. For example, with continued reference to FIG. 3, media playlist merger 312 may obtain 328 identifiers of items of media content from playlists 106A-106N and media content item scores associated with each item of media content. Media playlist merger 312 may generate merged media playlist 110 by combining identifiers of items of media content and ordering the identifiers based on the media content item scores generated by score generator 308. In one implementation, media playlist merger 312 may combine or aggregate media content item scores for identifiers associated with the same item of media content. For instance, if several playlists of playlists 106A-106N each contain an identifier associated with the same item of media content, media playlist merger 312 may combine the media content item scores during the generation of merged playlist 110.

As noted above, media playlist merger 312 may combine a plurality of identifiers of items of media content from playlists 106A-106N. Media playlist merger 312 may generate 332 merged playlist 110 using each identifier, or using a subset of identifiers across playlists 106A-106N. For instance, media playlist merger 312 may be configured to generate merged playlist 110 using the highest 10, 25, 50, 100, etc. media content item scores associated with each item of media content. In another example embodiment, merged playlist 110 may be generated using only songs that have media content item scores that exceed a threshold value.

Media playlist merger 312 may also be configured to order items of media content in merged playlist 110 based on media content item scores. For instance, merged playlist 110 may be ordered with the identifier of media content having the highest media content item first and the identifier with the lowest media content item score last (i.e., in descending order). Any other ordering based on scoring is also contemplated, such as ordering identifiers of media content items with alternating high and low media content item scores (e.g., ordering items with the highest score, lowest score, second highest score, second lowest score, etc.). Ordering of identifiers of media content in merged playlist 110 may also take into account the order of the identifiers in the playlist from which they are obtained.

In one implementation, media playlist merger 312 may add duplicate identifiers to merged playlist 1100, for instance, where an identifier has a media content item score that exceeds a threshold amount. As an illustrative example, if a particular song has a high media content item score that suggests a strong preference by one or more users, media playlist merger 312 may order merged playlist 110 based on media content item scores as described above, and add a duplicate identifier for the particular song after every 10, 20, 50, etc. songs. In this manner, items of media content that are identified as being of strong interest may appear in merged playlist 110 more often than other songs.

In another example implementation, media playlist merger 312 may also obtain 330 a randomization instruction from randomizer 314 for at least partly randomizing an order of merged playlist 110. For instance, randomizer 314 may rearrange an ordering to prevent similar items of media content being played in succession (e.g., preventing multiple songs from the same artist or album being played one after another). For instance, randomizer 314 may move an identifier associated with an item of media content from one location in merged playlist 110 to another random location in merged playlist 110. Randomizer 314 may also be configured to randomly determine an ordering for merged playlist 110 altogether. As an example, media playlist merger 312 may generate a merged list by combining identifiers associated with media item scores beyond a threshold value, or combining identifiers associated with a predetermined number of the highest media item scores (e.g., the top 50 media item scores). Media playlist merger 312 may utilize randomizer 314 to randomly generate an ordering for the combined identifiers, thereby generating merged playlist 110.

In another implementation, media playlist merger 312 may also be configured to obtain feature values generated by feature extractor 304 and/or feature scores generated by score generator 308 for each feature associated with each item of media content. Media playlist merger 312 may use the feature values and/or feature scores to identify additional items of media content not present in merged playlist 110. For example, media playlist merger 312 may determine that playlists 106A-106N contain a relatively high frequency of one or more feature values (e.g., particular artist, genre, tempo, etc.) and/or an elevated feature score or media content item score for certain items of media content, and automatically infer that such feature values or items of media content are of relatively high interest to users of playlists 106A-106N. Based on this information, media playlist merger 312 may identify one or more additional items of media content (e.g., from media content streaming service 112). For example, media playlist merger 312 may automatically add additional songs by the same artist, songs in the same genre, songs with a similar tempo, etc. to merged playlist 110. Accordingly, not only is media playlist merger 312 configured to generate merged playlist 110 based on identifiers contained within playlists 106A-106N, media playlist merger 312 may also include additional items of media content that expected to match the interests or preferences of users of playlist 106A-106N.

While it has been described herein that one or more components of playlist repository 104, media content playlist merger 108, merged playlist 110, media content streaming service 112, and media content 114 are implemented in media content delivery service 102, other implementations are also contemplated. For instance, one or more components or subcomponents of media content delivery service 102 may be located remotely from each other, may be on separate physical or virtual machines, may be implemented on one or more user devices, or may be part of a distributed processing system. In some other example embodiments, feature extractor 304 may obtain feature values for each of a plurality of items identified in a playlist and/or score generator 308 may generate media content item scores for each item each time a user creates, generates, or modifies a media playlist. As a result, when it is time for media playlist merger 312 to generate merged playlist 110, processing associated with obtaining feature values and generating media content item scores may not be necessary at such time, thereby increasing the speed at which a merged playlist may be generated.

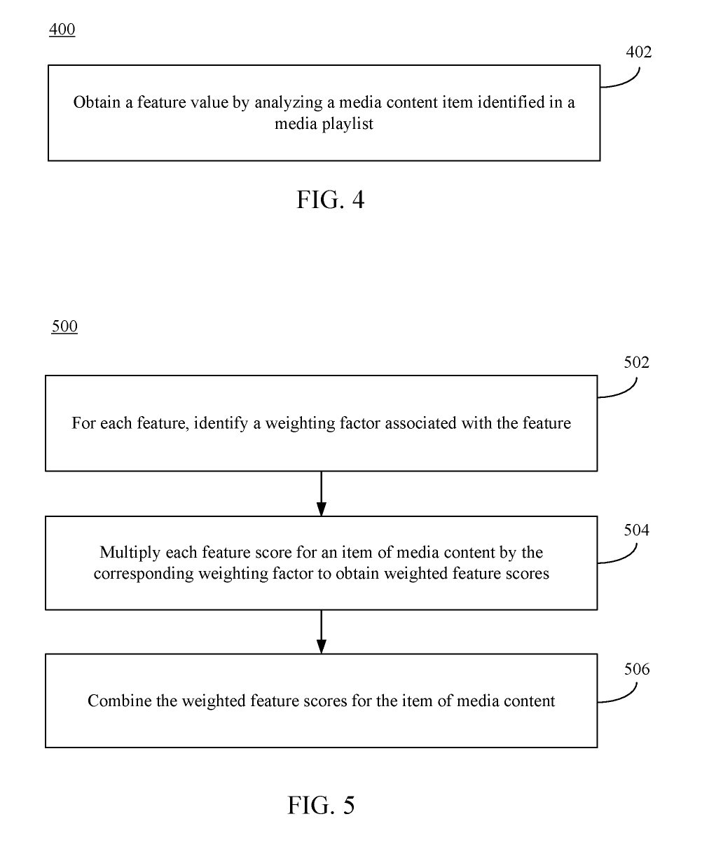

As described above, in examples, feature extractor 304 may obtain a feature value for an item of media content in various ways. For instance, FIG. 4 shows a flowchart 400 of a method for obtaining a feature value associated with a media content item, according to an example embodiment. In an example, the method of flowchart 400 may be implemented by feature extractor 304, as shown in FIG. 3. Other structural and operational implementations will be apparent to persons skilled in the relevant art(s) based on the following discussion regarding flowchart 400.

Flowchart 400 begins with step 402. In step 402, a feature value is obtained by analyzing a media content item identified in a media playlist. For instance, with reference to FIG. 3, feature extractor 304 may extract a digital representation of an item of media content identified in one of playlists 106A-106N and analyze the digital representation to obtain one or more feature values. In one implementation, feature extractor 304 may analyze an audio waveform or other representation identifying an audio signal, a sound characteristic, and/or a frequency characteristic associated with an item of media content. Feature extractor 304 may analyze the digital representation of an item of media content to identify an instrument played in the item of media content, a tempo, a beat, a pitch, a dynamic range value, a loudness amount, a bass amount, and/or a treble amount. The illustrative list of feature values that may be obtained by analyzing a digital representation of an item of media content is not intended to be limiting, but rather may include any other type of media content characteristic that may be obtained or derived from analyzing a digital representation of an item of media content.

In another example, feature extractor 304 may analyze metadata associated with an item of media content to obtain one or more feature values for the item. For example, feature extractor may obtain metadata information from an ID3 tag or the like associated with an item of media content, or obtain such information from another service (e.g., media content streaming service 112 or another cloud service). Feature extractor 304 may determine feature values for a number of different features based on metadata associated with an item of media content, including but not limited to a name, size, or gender of a song artist or composer, an album name, a song name, a song length, a genre, a country of origin, a language, an intended audience, a creation or release date, a soundtrack indicator, an indication whether a song is an original recording and/or a cover version, whether a song was live or prerecorded, and/or an amount of plays or popularity rating or ranking.

By analyzing a digital representation or metadata associated with an item of media content, a user need not manually listen to each item of media content and identify such feature values. Rather, feature extractor 304 may obtain such feature values automatically, thus decreasing the time expended by a user and a risk of human error in inaccurately identifying feature values for each feature for each item of media content.

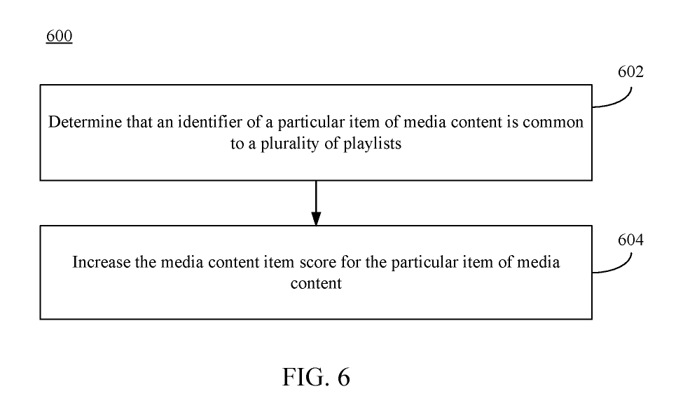

As described above, in examples, score generator 308 may generate a media content item score for an item of media content in various ways. For instance, FIG. 5 shows a flowchart 500 of a method for generating a media content item score for an item of media content by multiplying feature scores by a weighting factor, according to an example embodiment. In an example, the method of flowchart 500 may be implemented by score generator 308, as shown in FIG. 3. Other structural and operational implementations will be apparent to persons skilled in the relevant art(s) based on the following discussion regarding flowchart 500.

Flowchart 500 begins with step 502. In step 502, a weighting factor associated with each feature is identified. For example, with reference to FIG. 3, score generator 308 may identify 326 weighting factors 310 associated with features 306, with each weighting factor corresponding respectively to a particular feature. In implementations, weighting factors 310 may be utilized where score generator 308 is configured to generate a plurality of feature scores respectively corresponding to a plurality of features for each item of media content in each of playlists 106A-106N.

In an example embodiment, weighting factors 310 may comprise tunable parameters of media content playlist merger 108 such that an administrator or user of media content playlist merger 108 (e.g., a user desiring to play back items in merged playlist 110, such as a user of media content playback client 118) may assign weighting factors associated with one or more features. For instance, a weighting factor may represent a measure of importance of a particular to the administrator or user, and may be assigned to any one or more of features 306, with each weighting factor comprising any value. In other words, weighting factors 310 may be configured to emphasize or deemphasize the scoring associated with one or more features. For example, a weighting factor may be a relatively small or even a negative value if a particular feature is not desirable to an administrator or user. The weighting factor for a particular feature may be zero where the particular feature is not relevant to generating a merged playlist. In another example, the weighting factor for a particular feature may be a relatively high value where the feature may be important to an administrator or user. However, it is noted that weighting factors 310 may be relative to each other, such that any manner of scaling may be utilized in assigning weighting factors 310. For instance, a weighting factor above a value of one may represent a feature that is important to the administrator or user, while a weighting factor below a value of one may represent a feature that is not important to the administrator or user.

In an implementation, one or more weighting factors 310 may be configured 336 through user interface 316, in a similar manner described above with the configurability of features 306. In another example, however, one or more weighting factors 310 may be predetermined and/or not configurable by a user. As an example, if a user desires that media playlist merger 312 merge playlists based on a relatively high emphasis on a tempo (or any other feature described herein, such as artist, bass, treble, etc.), the weighting factor associated with the tempo feature may be set relatively higher than other weighting factors. For instance, the tempo weighting factor may be set at 5 (or any value), while one or more other weighting factors, such as weighting factors corresponding to an artist feature and a genre feature, may be set at 0.5 and 2, respectively (or any other value less than 5 in this illustrative example). In another example, weighting factors 310 may be based on a schedule (e.g., a time of day). For instance, score generator 308 may utilize a first set of weighting factors 310 during mornings, a second set of weighting factors 310 for afternoons, and a third set of weighting factors for evenings.

Accordingly, in some example embodiments, the manner in which certain features are emphasized and/or deemphasized in generating merged playlist 110 may be tuned based on an environment and/or setting of media content playback client 118, and/or the preferences of an administrator or user of media content playlist merger 108.

In step 504, each feature score for an item of media content is multiplied by the corresponding weighting factor to obtained weighted feature scores. For instance, with continued reference to FIG. 3, score generator 308 may be configured to multiply each generated feature score (e.g., as described above with respect to step 206) with a corresponding weighting factor to obtain a weighted feature score. As described above, since weighting factors 310 may serve to emphasize and/or deemphasize one or more of feature 306, the resulting weighted feature scores generated by score generator 308 represent feature scores particular to each item of media content based on desired emphasis or deemphasis.

In step 506, the weighted feature scores for an item of media content are combined. For instance, with respect to FIG. 3, score generator 308 may be further configured to combine each of the weighted feature scores for a particular item of media content identified in one of playlists 106A-106N to generate a media content item score for the item. The weighted feature scores may be combined in a similar manner as described earlier with respect to step 208 of FIG. 2 (e.g., by aggregation, mathematical analysis, statistical analysis, etc.). In this manner, each item of media content identified in each of playlists 106A-106N may comprise a single media content item score that takes into account not only features specific to each item of media content, but also weights assigned to each of such features. As a result, media playlist merger 312 may generate merged playlist 110 based on a number of configurable parameters to match both the preferences of users of playlists 106A-106N and/or users of media content playback client 118.

In a non-limiting illustrative example, score generator 308 may generate feature scores for a particular item of media content corresponding to a tempo feature, an artist feature, and a genre feature as 0.5, 0.2, and 0.8, respectively. If weighting factors 310 identified weighting for the tempo feature, artist feature, and genre feature as 5, 0.5, and 2, respectively, score generator 308 may generate weighted feature scores for the particular item of media content as 2.5 for the tempo feature, 0.1 for the artist feature, and 1.6 for the genre feature. Score generator 308 may combine all of the weighted feature scores for this particular item of media content to generate a media content item score of 4.2. In example embodiments, this score generation process may be performed for each feature for each item of media content in playlists 106A-106N. As described herein, media playlist merger 312 may generate merged playlist 110 based at least on the media content item scores for the plurality of items of media content. It is noted that the number of features and the weighting factor values in this illustrative example are not limiting, and any number of features and any weighting factor values may be utilized.

In embodiments, media playlist merger 312 may selectively increase a media content item score for a particular item of media content. For instance, FIG. 6 shows a flowchart 600 of a method for increasing a media content item score associated with an item of media content, according to an example embodiment. In an example, the method of flowchart 600 may be implemented by media playlist merger 312, as shown in FIG. 3. Other structural and operational implementations will be apparent to persons skilled in the relevant art(s) based on the following discussion regarding flowchart 600.

Flowchart 600 begins with step 602. In step 602, it is determined that an identifier associated with a particular item of media content is common to a plurality of media playlists. For instance, with reference to FIG. 3, media playlist merger 312 may determine that a plurality of playlists 106A-106N comprise identifiers identifying a common item of media content. As one example, multiple playlists 106A-106N may contain an identifier associated with the same song. In embodiments, media playlist merger 312 may identify common items of media content by comparing identifiers and/or metadata associated with songs for which media content item scores are generated, and/or by comparing a digital representation of items of media content.

Since score generator 308 is configured to generate a score for each item of media content in each of playlists 106A-106N, score generator 308 separately generates feature scores for the item of media content based on the playlist in which it is identified, along with separate media content item scores. In embodiments, because playlists 106A-106N are likely to comprise different sets of identifiers for items of media content, the feature scores and media content item scores associated with a particular item of media content common across multiple playlists may be different from each other.

In step 604, the media content item score for the particular item of media content is increased. For example, with continued reference to FIG. 3, media playlist merger 312 may increase the media content item score generated by score generator 308 associated with the common item of media content. In implementations, where the same item of media content is identified across multiple playlists, media playlist merger 312 may deduce that the particular item of media content is of common interest to the users of playlists 106A-106N, and therefore increase a score associated with the item. In one implementation, media playlist merger 312 may combine or aggregate media content item scores for identifiers associated with the common item of media content. For instance, if several playlists of playlists 106A-106N each contain an identifier associated with the same item of media content, media playlist merger 312 may combine the media content item scores that score generator 308 separately generated for the same item of media content. Media playlist merger 312 may also increase the media content item score in other manners, such as adding a fixed amount to the generated media content item score, adding a variable amount based on a number of playlists in which the same identifier appears, or using any other manner. Accordingly, items of media content that are common to a plurality of playlists 106A-106N may be assigned an increased overall score.

In one implementation, media playlist merger 312 may be configured to identify duplicate identifiers associated with the same item of media content across a plurality of playlists 106A-106N and add only a single identifier in merged playlist 110. For instance, upon identifying common items of media content, media playlist merger 312 may increase a score associated with the item of media content and include a single instance of the identifier for the common item of media content to merged playlist 110 based on the increased media content item score, thereby avoiding duplicate identifiers in merged playlist 110.

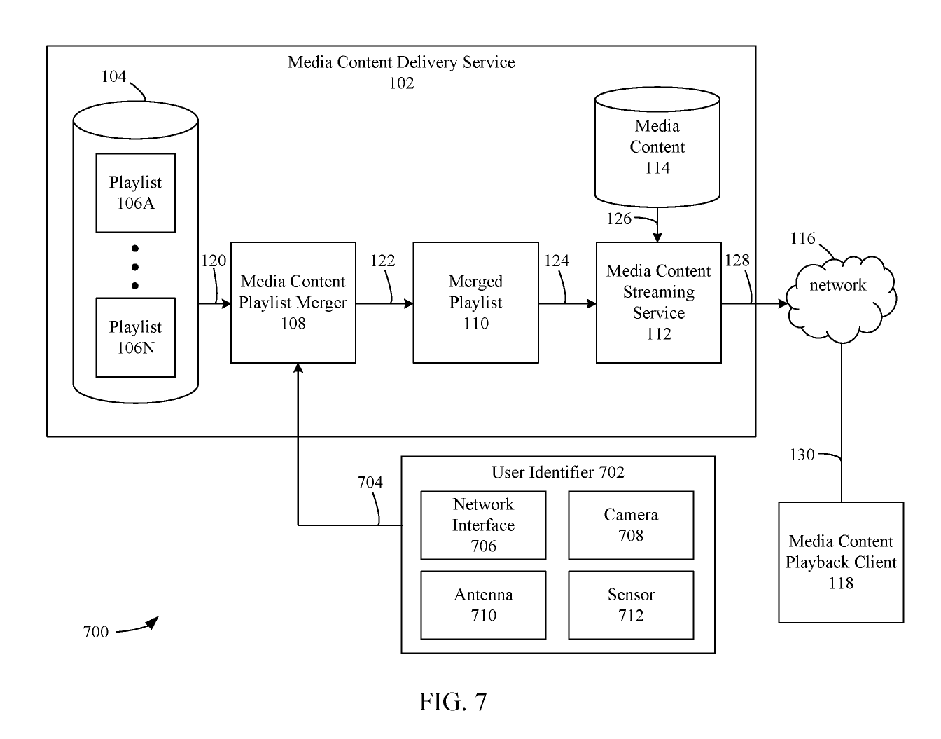

As described above, in an implementation, playlists 106A-106N may correspond to a plurality of different users or user devices. In an example, FIG. 7 shows a block diagram of an example system 700 for generating a merged media playlist upon identifying one or more users, according to an example implementation. In an example, system 700 of FIG. 7 is similar to system 100 of FIG. 1. However, as shown in FIG. 7, system 700 may further comprise a user identifier 702.

User identifier 702 may be configured to detect the presence of one or users and may comprise a network interface 706, a camera 708, an antenna 710, and a sensor 712. In embodiments, user identifier 702 may be geographically collocated with media content playback client 118. Although user identifier 702 is shown as separate from media content playback client 118 in FIG. 7, it is contemplated that user identifier 702 may be implemented as part of or within media content playback client 118, or may be coupled to media content playback client 118 via any suitable interface (e.g., a network interface, a wireless interface, a wired interface, etc.). In one example, user identifier 702 may comprise a device, such as a computing device, capable of detecting the presence of one or more users. For instance, user identifier 702 may be a mobile device, including but not limited to a mobile computing device (e.g., a Microsoft® Surface® device, a personal digital assistant (PDA), a laptop computer, a notebook computer, a tablet computer such as an Apple iPad™, a netbook, etc.), a mobile phone, a handheld video game device, or a wearable computing device. User identifier 702 may also be a stationary computing device such as but not limited to a desktop computer or PC (personal computer), a video game console, a set-top box, or a television.

In embodiments, user identifier 702 may detect the presence of one or more users in a variety of ways. For example, user identifier 702 may receive a presence indication from a mobile device associated with a user. In such an example, a user nearby to media content playback client 118 may wish to include a playlist associated with the user in the generation of merged playlist 110. The user may manually cause a device associated with the user to transmit a presence indication to user identifier 702, indicating that the user is present and desires to provide access to the user's playlist (e.g., one of playlists 106A-106N that may be stored in a repository, such as a cloud-based repository). The presence indication may comprise any form and/or manner of transmission, such as receiving a presence indication via network interface 706. The presence indication may be transmitted in the form of wired or wireless signals. In implementations, network interface 706 may be configured to receive a presence indication via a text message (e.g., through a cellular network), a message or indication transmitted over a local area or wide area network, a message or indication transmitted using an application installed on the user device. In other implementations, user identifier 702 may detect the presence of a user based on a user scanning a barcode or a Quick Response (QR) code located nearby to user identifier 702, checking in at a counter or kiosk, or any other suitable manner. In yet another example, a user may also indicate his or her presence by interacting with a home automation or home assistant device, such as a Google® Home device or Amazon® Alexa device, or the like.

In another example, a user device may automatically transmit a presence indication to user identifier 702 based on the user being within a certain proximity. For instance, a user's presence may be detected automatically based on a location identified by Global Positioning System (GPS) sensor of the user device, a wireless or network connection using network interface 706 and/or antenna 710 (e.g., by detecting a Wi-Fi connection based on the IEEE 802.11 standards, a Bluetooth™ connection developed by the Bluetooth™ Special Interest Group, ZigBee communications or other personal area networks, a Near-Field Communication (NFC) transmission, etc.), or any other manner.

In yet another example, the presence of one or more users may be detected using camera 708 coupled to user identifier 702. For instance, camera 708 may scan an individual user, or a group of users (e.g., an entire room) and employ facial recognition techniques as will be understood and appreciated by one skilled in the art to identify one or more users. In another example, user identifier 702 may utilize sensor 708, such as a biometric sensor, to detect the presence of one or more users. In one implementation, sensor 708 may comprise a retinal scanner or a fingerprint reader configured to detect the presence of one or more users.

Upon identifying one or more users in any of the manners described herein, or using any other suitable manner, user identifier 702 may provide 704 the identity of the one or more detected users to media content playlist merger 108. For example, with reference to FIG. 3, media playlist obtainer 302 may obtain one or more playlists (e.g., one of playlists 106A-106N) associated with a group of detected users, so that such playlists may be merged in a manner described elsewhere herein. Accordingly, in implementations, when the presence of a group of users is detected by user identifier 702, media content playlist merger 108 may utilize a playlist associated with each detected user in generating merged playlist 110. This approach has numerous advantages, including enabling media content playlist merger 108 to automatically generate merged playlist 110 based on user identifier 702 identifying one or more users. For example, since user identifier 702 may automatically identify such users, users need not manually identify themselves (or manually submit a corresponding playlist, provide account information, etc.) for media content playlist merger 108 to generate merged playlist 110.

In implementations, media content playlist merger 108 may be configured to continuously receive the identities of users detected by user identifier 702. For instance, media content playlist merger 108 may generate an updated merged playlist 110 each time a new user is detected, or a previously detected user is no longer present. In other implementations, media content playlist merger 108 may be configured to generate an updated merged playlist 110 at periodic intervals (e.g., every 30 minutes, every hour, etc.), or when a threshold number of users has been detected or are no longer present. Implementations, however, are not limited to these illustrative examples, and may include other manners of generating an updated merged playlist 110. Media content playlist merger 108 may also be configured to generate an updated merged playlist 110 in the background while media content playback client 118 is streaming items of media content for presentation on an output device.

Media content playlist merger 108 may also be configured to obtain user feedback and generate an updated merged playlist 110. For instance, a user may interact with a user device (not shown) or an on-site terminal, such as media content playback client 118, to indicate an approval and/or disapproval of one or more items in merged playlist 110. A user may provide a thumbs-up or thumbs-down indication, a rating (e.g., a certain number of stars), or a like/dislike indication. In some example embodiments, a user may further identify a reason for approving or disapproving of one or more items of media content (e.g., the user did not prefer the genre or tempo of items in merged playlist 110). Based on such feedback, media content playlist merger may alter a manner in which a subsequent playlist is generated, e.g., by adding or removing one or more features 306 for which feature values are obtained, and/or modifying one or more weighting factors 310 associated with features 306. As a result, media content playlist merger 108 may be configured to generate an updated playlist that matches the tastes of a plurality of users or a particular user.

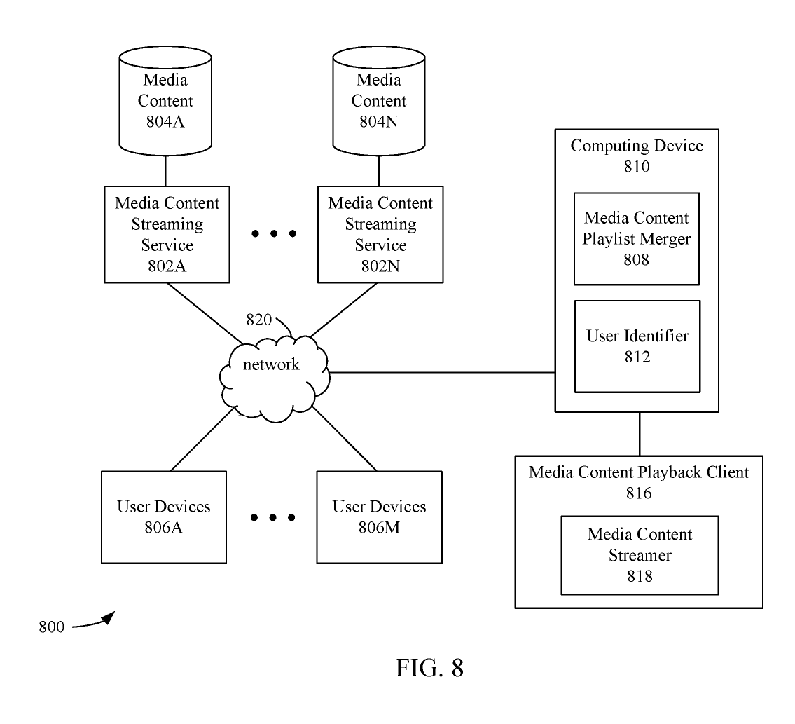

In another example implementation, generation of a merged playlist may be outsourced to another device. In an example, FIG. 8 shows a block diagram of an example system 800 for generating a merged media playlist on a computing device, according to an example embodiment. System 800 includes media content streaming services 802A-802N, media content repositories 804A-804N, user devices 806A-806M, a computing device 810, and a media content playback client 816. In embodiments, media content streaming services 802A-802N and media content repositories 804A-804N may be similar to media content streaming service 112 and media content repository 114, respectively, described above with reference to FIG. 1. Network 820 and media content playback client 816 may also be similar to network 116 and media content playback client 118, respectively, described with reference to FIG. 1.

Media content streaming services 802A-802N may comprise one or more different services to stream items of media content from media content repositories 804A-804N. Similar to media content streaming service 112 of FIG. 1, media content streaming services 802A-802N may each be implemented on one or more servers coupled to network 820. In an embodiment, media content streaming services 802A-802N may be configured to store media playlists associated with user devices. For instance, although not shown in FIG. 8, each of media content streaming services 802A-802N may each contain repositories comprising playlists associated with one or more user devices.

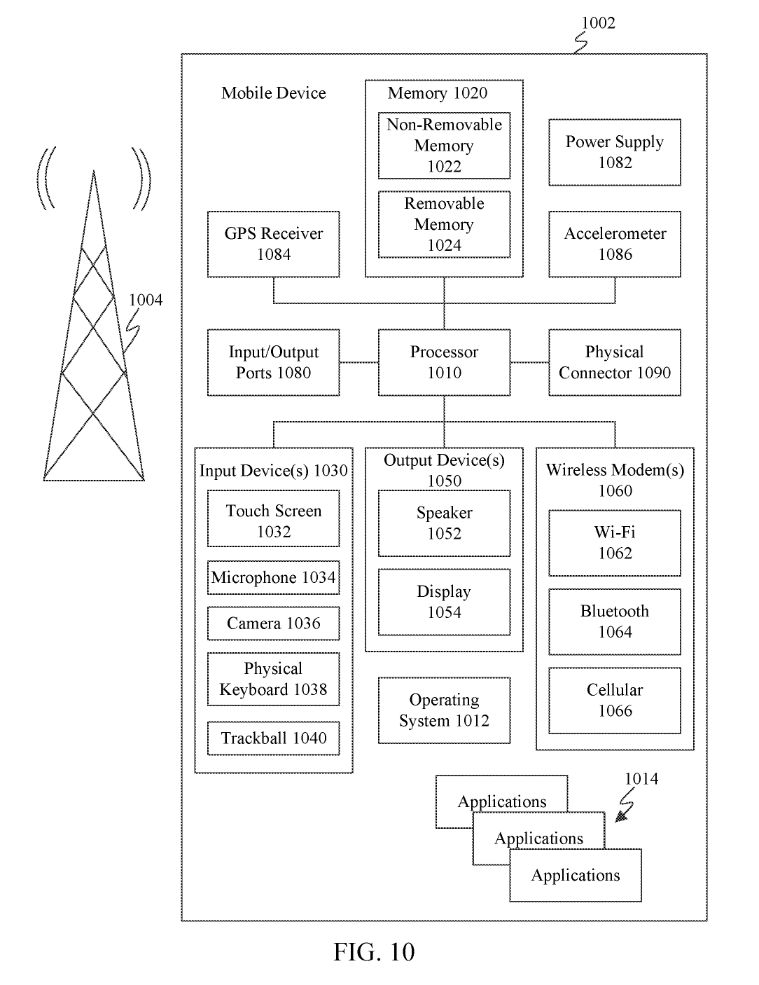

User devices 806A-806M may comprise one or more device configured to store and/or access a playlist and/or media content identified in the playlist. In one example, user devices 806A-806M may comprise one or devices of users and may include mobile devices, including but not limited to a mobile computing device (e.g., a Microsoft® Surface® device, a personal digital assistant (PDA), a laptop computer, a notebook computer, a tablet computer such as an Apple iPad™, a netbook, etc.), a mobile phone, a handheld video game device, or a wearable computing device. An example of such a device is described below with reference to FIG. 10. In implementations, one or more user devices 806A-806M may be located in a relatively close proximity to computing device 810 and/or media content playback client 816, but may also be located remotely in other implementations.

As noted above, user devices 806A-806M may comprise devices of users associated with a media playlist. For example, user devices 806A-806M may store a media playlist locally on such a device, on a cloud-based storage accessible via the user device, and/or be associated with a playlist stored in a repository of a streaming service (e.g., one of media content streaming services 802A-802N). Similarly, user devices 806A-806M may also comprise media content repositories to store items of media content identified in each respective playlist. For instance, a user device may store both a media playlist and each media content item identified in the media playlist locally. In another example, a user device may store a media playlist locally, while items of media content are accessed remotely (e.g., from a cloud-based storage or from a streaming service). In yet another implementation, both the media playlist and items of media content associated with a user device may be located remotely from the user device.

In some example embodiments, user devices 806A-806M may be configured to purchase a merged media playlist generated by media content playlist merger 808 and/or download the merged playlist to the user device or to a remotely located repository. For instance, user devices 806A-806M may comprise a user interface for purchasing/downloading such a playlist. In another example, a user interface of user devices 806A-806M may enable a user to modify a downloaded playlist, and/or modify a merged playlist currently being played or streamed by media content playback client 816.

Note that the variables “N” and “M” are appended to various reference numerals for illustrated components in FIG. 8 to indicate that the number of such components is variable, with any value of 2 and greater. Note that for each distinct component/reference numeral, the variables “N” and “M” have a corresponding value, which may be different for the values of “N” and “M” for other components/reference numerals. The values of “N” and “M” for any particular component/reference numeral may be less than 10, in the 10s, in the hundreds, in the thousands, or even greater, depending on the particular implementation.

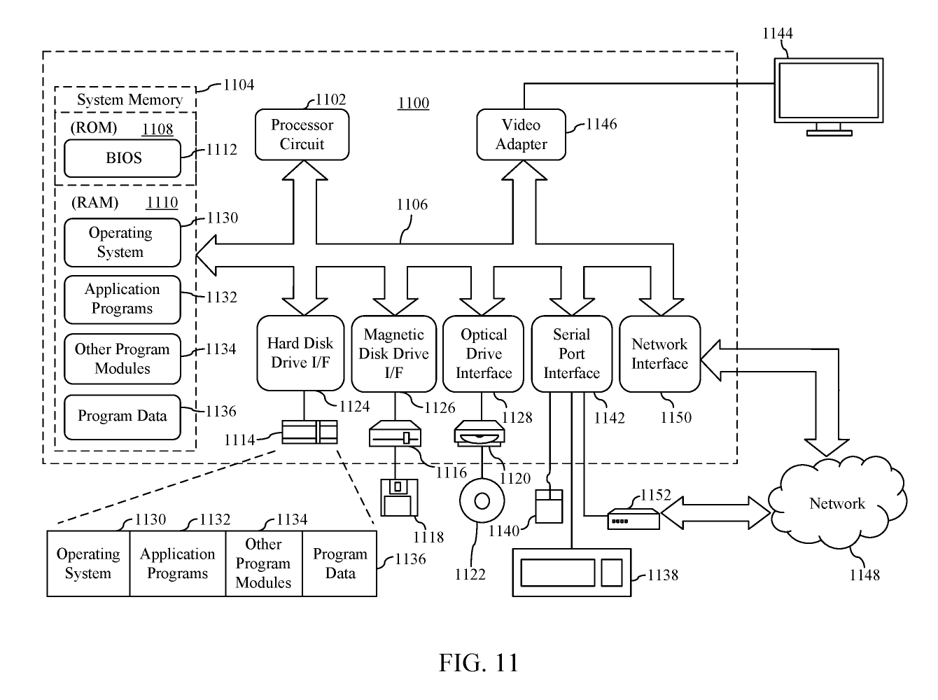

Computing device 810 may comprise a computing device configured to merge items of media content from various playlists obtained from one or more sources. Computing device 810 may be a mobile device (e.g., a non-limiting example of which is described with reference to FIG. 10 below) or a stationary computing device (e.g., a non-limiting example of which is described with reference to FIG. 11 below). In another example embodiment, computing device 810 may be implemented on a cloud-based platform. Accordingly, computing device 810 may be distributed to or across one or more physical machines, virtual machines, nodes, or servers.

As shown in FIG. 8, computing device 810 comprises media content playlist merger 808. Media content playlist merger 808 is similar to media content playlist merger 108 of FIGS. 1 and 3 and may comprise each of the components identified therein. For instance, media content playlist merger 808 may obtain a plurality of playlists, each of which comprise a plurality of identifiers identifying items of media content and generate a merged media playlist in accordance with the techniques described herein. As shown in the example embodiment of FIG. 8, computing device 812 further comprises a user identifier 812, which may be similar to user identifier 702 described with reference to FIG. 7. In example embodiments, user identifier 812 is configured to identify one or more users in a relatively close proximity to computing device 810 and/or media content playback client 816 wishing to share a playlist for inclusion in a merged playlist generated by media content playlist merger 808. In a manner similar to the one described above with reference to FIG. 7, user identifier 812 may detect one or more users via a network interface, camera, antenna, sensor, and/or any other suitable manner. Upon user identifier 812 detecting one or more users, media content playlist merger 808 (e.g., via media playlist obtainer 302 described with reference to FIG. 3) may obtain a playlist associated with each detected user.

As shown in FIG. 8, therefore, media content playlist merger 808 may obtain media playlists from a variety of different sources, such as from user devices 806A-806M, playlists associated with user devices 806A-806M stored on one or more of media content streaming services 802A-802M, and/or user playlists stored on cloud storage (not shown). In one example, media playlist obtainer 302 may normalize playlists obtained from different playlist sources such that each playlist is in the same or similar format. In this manner, system 800 may thereby be configured to generate a merged playlist independent of the source from which the plurality of playlists is obtained. System 800 may further modify a type, content, and/or format of the merged playlist such that it may be supported by one or more services (e.g., media content streaming services) and/or media playback clients.

Media content playback client 816 may be similar to media content playback client 118 of FIG. 1. In embodiments, media content playback client 816 may include or be coupled to an output device for playing back items of media content identified in a merged playlist. Although shown separate from computing device 810 in FIG. 8, media content playback client 816 may be implemented as part of computing device 810 or be geographically collocated with computing device 810. Media content playback client 816 may also comprise a media content streamer 818 configured to stream items of media content identified in a merged playlist generated by media content playlist merger 808. For instance, media content streamer 818 may stream items of media content for playback identified in a merged playlist from any one of media content streaming services 802A-802N (e.g., through media content repositories 804A-804N, respectively). In another implementation, media content streamer 818 may stream items of media content in a merged playlist from user devices 806A-806M via a network, wired, or wireless connection. In yet another implementation, media content streamer 818 may stream items of media content in a merged playlist from a combination of sources (e.g., one or more of media content streaming services 802A-802N and/or one or more of user devices 806A-806M). For example, media content streamer 818 may be configured to obtain items of media content from a plurality of media content sources (e.g., Spotify®, Pandora®, Tidal®, Apple® Music, etc.). If a particular item of media content identified in a merged playlist is not available for streaming from one media content source but is available for streaming from a second media content source, media content streamer 818 may automatically stream the particular item of media content from the second media content source.

It is also noted that media content streaming, as described herein, may also include downloading items of media content to a local storage and accessing the items in the local storage during playback. For instance, media content playback client 816 and/or computing device 810 may download to a local storage one or more items of media content from any number of sources and media content streamer 818 may access such items during playback.

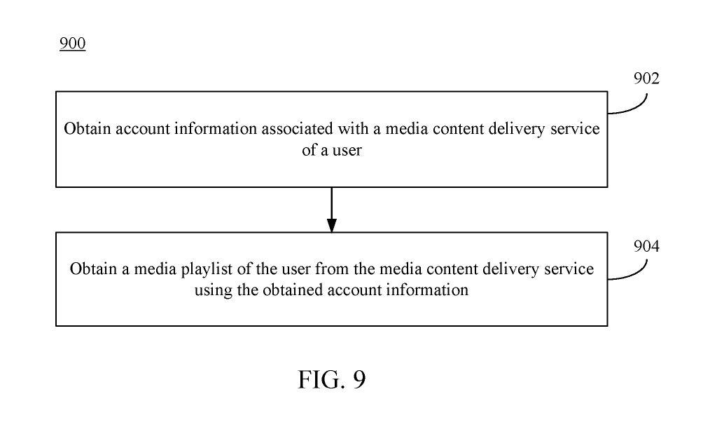

As described above, in an implementation, media content playlist merger 808 may obtain a playlist associated with a user in a variety of ways. In an example, FIG. 9 shows a flowchart 900 of a method for obtaining a media playlist of a user. In an example, the method of flowchart 800 may be implemented by media playlist obtainer 302 as shown in FIG. 3 and user identifier 812 as shown in FIG. 8. Other structural and operational implementations will be apparent to persons skilled in the relevant art(s) based on the following discussion regarding flowchart 900.

Flowchart 900 begins with step 902. In step 902, account information associated with a media content delivery service of a user is obtained. For instance, with reference to FIG. 8, user identifier 812 may be configured to obtain user account information for a media content delivery service associated with the user. As shown in FIG. 8, the media content delivery service may be part of one or more of media content streaming services 802A-802N. In one example, a media content delivery service may include a service configured to stream items of media content to a user device, such as services provided by Spotify®, Pandora®, Tidal®, Apple® Music, etc. In accordance with step 902, one or more of user devices 806A-806M may transmit account information to user identifier 812 via any suitable interface, such as wired connection, a wireless connection, a network connection, by inputting such information on user interface coupled to computing device 810 or media content playback client 816, by email, by text message, etc. In implementations, account information associated with a media content delivery service may include any one or more of a username, an email address, an account number, a subscription identifier, a password, a telephone or mobile phone number, etc.

In step 904, a media playlist of the user is obtained from the media content delivery service using the obtained account information. For instance, with reference to FIGS. 3 and 8, media playlist obtainer 302 may use the account information to obtain a media playlist associated with a user from a media content delivery service (e.g., one of media content streaming services 802A-802N). In an implementation, media playlist obtainer 302 may login to the appropriate media content streaming service using the obtained user account credentials and access the playlist associated with the user. In an example, media playlist obtainer 302 may download an entire playlist associated with the user, or may separately obtain each identifier of media content identified in the playlist. Upon obtaining a media playlist associated with the user using the appropriate account information, media content playlist merger 808 may generate a merged media playlist in accordance with the techniques discussed herein.

In another implementation, a user may provide account information associated with a plurality of users. For example, a user may desire to utilize media content playlist merger 808 to generate a merged playlist for a select group of users (e.g., friends, family members, celebrities, etc.). A user may identify account information associated with such other users (e.g., names of those users, email addresses, etc.). Media playlist obtainer 302 may use the account information to obtain playlists associated with the plurality of identified users, thereby enabling media content playlist merger 808 to generate a merged playlist based on a select group of users, even though such users may or may not be located near computing device 810 or media content playback client 816.

### III. Example Mobile Device Implementation

FIG. 10 is a block diagram of an exemplary mobile device 1002 that may implement embodiments described herein. For example, mobile device 1002 may be used to implement any of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816. As shown in FIG. 10, mobile device 1002 includes a variety of optional hardware and software components. Any component in mobile device 1002 can communicate with any other component, although not all connections are shown for ease of illustration. Mobile device 1002 can be any of a variety of computing devices (e.g., cell phone, smartphone, handheld computer, Personal Digital Assistant (PDA), etc.) and can allow wireless two-way communications with one or more mobile communications networks 1004, such as a cellular or satellite network, or with a local area or wide area network.

The illustrated mobile device 1002 can include a controller or processor 1010 (e.g., signal processor, microprocessor, ASIC, or other control and processing logic circuitry) for performing such tasks as signal coding, data processing, input/output processing, power control, and/or other functions. An operating system 1012 can control the allocation and usage of the components of mobile device 1002 and provide support for one or more application programs 1014 (also referred to as “applications” or “apps”). Application programs 1014 may include common mobile computing applications (e.g., digital personal assistants, e-mail applications, calendars, contact managers, web browsers, messaging applications) and any other computing applications (e.g., word processing applications, mapping applications, media player applications).

The illustrated mobile device 1002 can include memory 1020. Memory 1020 can include non-removable memory 1022 and/or removable memory 1024. Non-removable memory 1022 can include RAM, ROM, flash memory, a hard disk, or other well-known memory devices or technologies. Removable memory 1024 can include flash memory or a Subscriber Identity Module (SIM) card, which is well known in GSM communication systems, or other well-known memory devices or technologies, such as “smart cards.” Memory 1020 can be used for storing data and/or code for running operating system 1012 and applications 1014. Example data can include web pages, text, images, sound files, video data, or other data to be sent to and/or received from one or more network servers or other devices via one or more wired or wireless networks. Memory 1020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1002 can support one or more input devices 1030, such as a touch screen 1032, a microphone 1034, a camera 1036, a physical keyboard 1038 and/or a trackball 1040 and one or more output devices 1050, such as a speaker 1052 and a display 1054. Other possible output devices (not shown) can include piezoelectric or other haptic output devices. Some devices can serve more than one input/output function. For example, touch screen 1032 and display 1054 can be combined in a single input/output device. The input devices 1030 can include a Natural User Interface (NUI).

Wireless modem(s) 1060 can be coupled to antenna(s) (not shown) and can support two-way communications between the processor 1010 and external devices, as is well understood in the art. The modem(s) 1060 are shown generically and can include a cellular modem 1066 for communicating with the mobile communication network 1004 and/or other radio-based modems (e.g., Bluetooth 1064 and/or Wi-Fi 1062). At least one of the wireless modem(s) 1060 is typically configured for communication with one or more cellular networks, such as a GSM network for data and voice communications within a single cellular network, between cellular networks, or between the mobile device and a public switched telephone network (PSTN).

Mobile device 1002 can further include at least one input/output port 1080, a power supply 1082, a satellite navigation system receiver 1084, such as a Global Positioning System (GPS) receiver, an accelerometer 1086, and/or a physical connector 1090, which can be a USB port, IEEE 1394 (FireWire) port, and/or RS-232 port. The illustrated components of mobile device 1002 are not required or all-inclusive, as any components can be deleted and other components can be added as would be recognized by one skilled in the art.

In an embodiment, mobile device 1002 is configured to perform any of the functions of any of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816. Computer program logic for performing the functions of these devices may be stored in memory 1020 and executed by processor 1010. By executing such computer program logic, processor 1010 may be caused to implement any of the features of any of these devices. Also, by executing such computer program logic, processor 1010 may be caused to perform any or all of the steps of flowcharts 200, 400, 500, 600, and 900.

### IV. Example Computer System Implementation

One or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900 may be implemented in hardware, or hardware combined with software and/or firmware. For example, one or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900 may be implemented as computer program code/instructions configured to be executed in one or more processors and stored in a computer readable storage medium.

In another implementation, one or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900 may also be implemented in hardware that operates software as a service (SaaS) or platform as a service (PaaS). Alternatively, one or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900 may be implemented as hardware logic/electrical circuitry.

For instance, in an implementation, one or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 11 depicts an implementation of a computing device 1100 in which example embodiments may be implemented. For example, media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816 may each be implemented in one or more computing devices similar to computing device 1100 in stationary or mobile computer implementations, including one or more features of computing device 1100 and/or alternative features. The description of computing device 1100 provided herein is provided for purposes of illustration, and is not intended to be limiting. Example embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random-access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136.

Application programs 1132 or other programs 1134 may include, for example, computer program logic (e.g., computer program code or instructions) for implementing one or more of the components of media content delivery service 102, media content playlist merger 108, media content streaming service 112, media content playback client 118, user identifier 702, media content streaming services 802A-802N, user devices 806A-806M, media content playlist merger 808, computing device 810, and media content playback client 816, and one or more steps of flowcharts 200, 400, 500, 600, and 900, and/or further implementations described herein.

A user may enter commands and information into the computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers. Display screen 1144, and/or any other peripheral output devices (not shown) may be used for implementing user interface 316, and/or any further implementations described herein.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media).

Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Implementations are also directed to such communication media that are separate and non-overlapping with implementations directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of example embodiments discussed herein. Accordingly, such computer programs represent controllers of the computing device 1100.

Implementations are also directed to computer program products comprising computer code or instructions stored on any computer-readable medium. Such computer program products include hard disk drives, optical disk drives, memory device packages, portable memory sticks, memory cards, and other types of physical storage hardware.

### V. Additional Example Embodiments

A system is described herein. The system includes: at least one processor circuit; at least one memory that stores program code configured to be executed by the at least one processor circuit, the program code comprising: a media playlist obtainer configured to obtain a plurality of media playlists, each media playlist including a plurality of identifiers, each identifier identifying an item of media content; a feature extractor configured to, for each item of media content identified in each media playlist: obtain a feature value for each of one or more features; a score generator configured to, for each item of media content identified in each media playlist: generate a feature score for each of the one or more features, wherein the feature score for a particular feature is based on a number of occurrences of the feature value associated with the particular feature in the media playlist in which the item of media content is identified; and generate a media content item score for the item of media content based on the one or more feature scores for the item of media content; and a media playlist merger configured to generate a merged media playlist by combining identifiers of items of media content from the plurality of media playlists and ordering the combined identifiers based at least on the media content item scores associated with the corresponding items of media content.

In one implementation of the foregoing system, the feature extractor is configured to obtain at least one feature value by analyzing a digital representation of an item of media content identified in one of the media playlists to determine at least one of: an instrument; a tempo; a beat; a pitch; a dynamic range value; or a loudness, bass, or treble amount.

In another implementation of the foregoing system, the feature extractor is configured to obtain at least one feature value by analyzing metadata associated with an item of media content identified in one of the media playlists to determine at least one of: an artist name, size, or gender; an album name; a song name; a song length; a genre; a country of origin; a language; an intended audience; a creation or release date; a soundtrack indicator; or a ranking or popularity.

In another implementation of the foregoing system, the one or more features comprise a plurality of features and the score generator is configured to generate a plurality of feature scores respectively corresponding to the plurality of features for each item of media content identified in each media playlist and generate the media content item score for each item of media content identified in each media playlist based on the plurality of feature scores for the item of media content by: identifying, for each of the plurality of features, a weighting factor associated with the feature; multiplying each of the plurality of feature scores for the item of media content by the corresponding weighting factor to obtain a plurality of weighted feature scores; and combining the plurality of weighted feature scores for the item of media content identified in the media playlist.

In another implementation of the foregoing system, the media playlist merger is further configured to: determine that an identifier of a particular item of media content is common to a plurality of media playlists; and increase the media content item score for the particular item of media content.

In another implementation of the foregoing system, the plurality of items of media content comprise one of: an audio playback item; an image; a video playback item; an audio/video playback item; or a video game map.

In another implementation of the foregoing system, the system further comprises: a user identifier that detects the presence of a user, the detection comprising one of: receiving a presence indication from a mobile device associated the user; detecting the user via a camera; or detecting the user via a biometric sensor; and the media playlist obtainer is configured to obtain a media playlist of the user.

In another implementation of the foregoing system, the media playlist obtainer is configured to: obtain account information associated with a media content delivery service account of a user; and obtain a media playlist of the user from the media content delivery service via a network using the obtained account information.

In another implementation of the foregoing system, the system further comprises a user interface for configuring at least one of: the weighting factors associated with the plurality of features; or a selection of at least one feature for which the feature extractor obtains a corresponding feature value.

In another implementation of the foregoing system, the system further comprises: an output device configured to present the items of media content in the merged media playlist.

A method is disclosed herein. The method includes: obtaining a plurality of media playlists, each media playlist including a plurality of identifiers, each identifier identifying an item of media content; for each item of media content identified in each media playlist, obtaining a feature value and a weighting factor for each of a plurality of features; generating a plurality of feature scores respectively corresponding to the plurality of features, wherein the feature score for a particular feature is based on a number of occurrences of the feature value associated with the particular feature in the media playlist in which the item of media content is identified; multiplying each of the plurality of feature scores by the corresponding weighting factor to obtain a plurality of weighted feature scores; and combining the plurality of weighted feature scores for the item of media content identified in the media playlist to generate a media content item score for the item of media content; and generating a merged media playlist by combining identifiers of items of media content from the plurality of media playlists and ordering the combined identifiers based at least on the media content item scores associated with the corresponding items of media content.

In one implementation of the foregoing method, the obtaining the feature value for each of the plurality of features comprises analyzing a digital representation of an item of media content identified in one of the media playlists to determine at least one of: an instrument; a tempo; a beat; a pitch; a dynamic range value; or a loudness, bass, or treble amount.

In another implementation of the foregoing method, the generating the merged media playlist comprises: determining that an identifier of a particular item of media content is common to a plurality of media playlists; and increasing the media content item score for the particular item of media content.

In another implementation of the foregoing method, the plurality of items of media content comprise one of: an audio playback item; an image; a video playback item; an audio/video playback item; or a video game map.

In another implementation of the foregoing method, the obtaining the plurality of media playlists comprises: detecting the presence of a user, the detecting comprising one of: receiving a presence indication from a mobile device associated the user; detecting the user via a camera; or detecting the user via a biometric sensor; and obtaining a media playlist of the user.

A computer program product is disclosed herein. The computer program product includes: a computer-readable memory having computer program logic recorded thereon that when executed by at least one processor causes the at least one processor to perform a method comprising: obtaining a plurality of media playlists, each media playlist including a plurality of identifiers, each identifier identifying an item of media content; for each item of media content identified in each media playlist, obtaining a feature value for each of one or more features; generating a feature score for each of the one or more features, wherein the feature score for a particular feature is based on a number of occurrences of the feature value associated with the particular feature in the media playlist in which the item of media content is identified; and generating a media content item score for the item of media content based on the one or more feature scores for the item of media content; and generating a merged media playlist by combining identifiers of items of media content from the plurality of media playlists and ordering the combined identifiers based at least on the media content item scores associated with the corresponding items of media content, the generating the merged media playlist comprising: determining that an identifier of a particular item of media content is common to a plurality of media playlists; and increasing the media content item score for the particular item of media content.

In another implementation of the foregoing computer program product, the obtaining the feature value for each of one or more features comprises analyzing a digital representation of an item of media content identified in one of the media playlists to determine at least one of: an instrument; a tempo; a beat; a pitch; a dynamic range value; or a loudness, bass, or treble amount.

In another implementation of the foregoing computer program product, the one or more features comprise a plurality of features and the generating the media content item score for the item of media content comprises: generating a plurality of feature scores respectively corresponding to the plurality of features for each item of media content in each media playlist; identifying, for each of the plurality of features, a weighting factor associated with the feature; multiplying each of the plurality of feature scores for the item of media content by the corresponding weighting factor to obtain one or more weighted feature scores; and combining the one or more weighted feature scores for the item of media content identified in the media playlist.

In another implementation of the foregoing computer program product, the plurality of items of media content comprise one of: an audio playback item; an image; a video playback item; an audio/video playback item; or a video game map.

In another implementation of the foregoing computer program product, the obtaining the plurality of media playlists comprises: detecting the presence of a user, the detecting comprising one of: receiving a presence indication from a mobile device associated the user; detecting the user via a camera; or detecting the user via a biometric sensor; and obtaining a media playlist of the user.

### VI. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the present invention should not be limited by any of the above-described example embodiments, but should be defined only in accordance with the following claims and their equivalents.

What is claimed is:

1. A system, comprising:
at least one processor circuit;
at least one memory that stores program code configured to be executed by the at least one processor circuit, the program code comprising:
a media playlist obtainer configured to obtain a plurality of media playlists, each media playlist including a plurality of identifiers, each identifier identifying an item of media content;
a feature extractor configured to, for each item of media content identified in each media playlist:
obtain a feature value for each of one or more features;
a score generator configured to, for each item of media content identified in each media playlist:
generate a feature score for each of the one or more features, wherein the feature score for a particular feature is based on a number of occurrences of the feature value associated with the particular feature in the media playlist in which the item of media content is identified; and
generate a media content item score for the item of media content based on the one or more feature scores for the item of media content; and
a media playlist merger configured to generate a merged media playlist by combining identifiers of items of media content from the plurality of media playlists and ordering the combined identifiers in the merged media playlist based at least on the media content item scores associated with the corresponding items of media content.

2. The system of claim 1, wherein the feature extractor is configured to obtain at least one feature value by analyzing a digital representation of an item of media content identified in one of the media playlists to determine at least one of:
an instrument;
a tempo;
a beat;
a pitch;
a dynamic range value; or
a loudness, bass, or treble amount.

3. The system of claim 1, wherein the feature extractor is configured to obtain at least one feature value by analyzing metadata associated with an item of media content identified in one of the media playlists to determine at least one of:
an artist name, size, or gender;
an album name;
a song name;
a song length;
a genre;
a country of origin;
a language;
an intended audience;
a creation or release date;
a soundtrack indicator; or
a ranking or popularity.

4. The system of claim 1, wherein the one or more features comprise a plurality of features and wherein the score generator is configured to generate a plurality of feature scores respectively corresponding to the plurality of features for each item of media content identified in each media playlist and generate the media content item score for each item of media content identified in each media playlist based on the plurality of feature scores for the item of media content by:
identifying, for each of the plurality of features, a weighting factor associated with the feature;
multiplying each of the plurality of feature scores for the item of media content by the corresponding weighting factor to obtain a plurality of weighted feature scores; and
combining the plurality of weighted feature scores for the item of media content identified in the media playlist.

5. The system of claim 1, wherein the media playlist merger is further configured to:
determine that an identifier of a particular item of media content is common to a plurality of media playlists; and
increase the media content item score for the particular item of media content.

6. The system of claim 1, wherein the plurality of items of media content comprise one of:
an audio playback item;
an image;
a video playback item;
an audio/video playback item; or
a video game map.

7. The system of claim 1, wherein the system further comprises:
a user identifier that detects the presence of a user, the detection comprising one of:
receiving a presence indication from a mobile device associated the user;
detecting the user via a camera; or
detecting the user via a biometric sensor; and
wherein the media playlist obtainer is configured to obtain a media playlist of the user.

8. The system of claim 1, wherein the media playlist obtainer is configured to:
obtain account information associated with a media content delivery service account of a user; and
obtain a media playlist of the user from the media content delivery service via a network using the obtained account information.

9. The system of claim 4, further comprising a user interface for configuring at least one of:
the weighting factors associated with the plurality of features; or
a selection of at least one feature for which the feature extractor obtains a corresponding feature value.

10. The system of claim 1, further comprising:
an output device configured to present the items of media content in the merged media playlist.

11. A method, comprising:
obtaining a plurality of media playlists, each media playlist including a plurality of identifiers, each identifier identifying an item of media content;
for each item of media content identified in each media playlist,
obtaining a feature value and a weighting factor for each of a plurality of features;
generating a plurality of feature scores respectively corresponding to the plurality of features;
multiplying each of the plurality of feature scores by the corresponding weighting factor to obtain a plurality of weighted feature scores; and
combining the plurality of weighted feature scores for the item of media content identified in the media playlist to generate a media content item score for the item of media content; and
generating a merged media playlist by combining identifiers of items of media content from the plurality of media playlists and ordering the combined identifiers in the merged media playlist based at least on the media content item scores associated with the corresponding items of media content.

12. The method of claim 11, wherein the obtaining the feature value for each of the plurality of features comprises analyzing a digital representation of an item of media content identified in one of the media playlists to determine at least one of:
an instrument;
a tempo;
a beat;
a pitch;
a dynamic range value; or
a loudness, bass, or treble amount.

13. The method of claim 11, wherein the generating the merged media playlist comprises:
determining that an identifier of a particular item of media content is common to a plurality of media playlists; and
increasing the media content item score for the particular item of media content.

14. The method of claim 11, wherein the plurality of items of media content comprise one of:
an audio playback item;
an image;
a video playback item;
an audio/video playback item; or
a video game map.

15. The method of claim 11, wherein the obtaining the plurality of media playlists comprises:
detecting the presence of a user, the detecting comprising one of:
receiving a presence indication from a mobile device associated the user;
detecting the user via a camera; or
detecting the user via a biometric sensor; and
obtaining a media playlist of the user.

16. A computer program product comprising a computer-readable memory having computer program logic recorded thereon that when executed by at least one processor causes the at least one processor to perform a method comprising:
obtaining a plurality of media playlists, each media playlist including a plurality of identifiers, each identifier identifying an item of media content;
for each item of media content identified in each media playlist,
obtaining a feature value for each of one or more features;
generating a feature score for each of the one or more features; and
generating a media content item score for the item of media content based on the one or more feature scores for the item of media content; and
generating a merged media playlist by combining identifiers of items of media content from the plurality of media playlists and ordering the combined identifiers in the merged media playlist based at least on the media content item scores associated with the corresponding items of media content, the generating the merged media playlist comprising:
determining that an identifier of a particular item of media content is common to a plurality of media playlists; and
increasing the media content item score for the particular item of media content.

17. The computer program product of claim 16, wherein the obtaining the feature value for each of one or more features comprises analyzing a digital representation of an item of media content identified in one of the media playlists to determine at least one of:
an instrument;
a tempo;
a beat;
a pitch;
a dynamic range value; or
a loudness, bass, or treble amount.

18. The computer program product of claim 16, wherein the one or more features comprise a plurality of features and wherein the generating the media content item score for the item of media content comprises:
generating a plurality of feature scores respectively corresponding to the plurality of features for each item of media content in each media playlist;
identifying, for each of the plurality of features, a weighting factor associated with the feature;
multiplying each of the plurality of feature scores for the item of media content by the corresponding weighting factor to obtain one or more weighted feature scores; and
combining the one or more weighted feature scores for the item of media content identified in the media playlist.

19. The computer program product of claim 16, wherein the plurality of items of media content comprise one of:
an audio playback item;
an image;
a video playback item;
an audio/video playback item; or
a video game map.

20. The computer program product of claim 16, wherein the obtaining the plurality of media playlists comprises:
detecting the presence of a user, the detecting comprising one of:
receiving a presence indication from a mobile device associated the user;
detecting the user via a camera; or
detecting the user via a biometric sensor; and
obtaining a media playlist of the user.
